(19) United States
(12) Patent Application Publication
(10) Pub. No.: US 2026/0291530 A1
(43) Pub. Date: Sep. 24, 2026

(54) MIXED INTERMEDIATE FREQUENCY CIRCUIT AND RADIO FREQUENCY CIRCUIT GAIN CONTROL

(71) Applicant: QUALCOMM Incorporated, San Diego, CA (US)

(72) Inventors: Damin CAO, San Diego, CA (US); Chuan WANG, San Diego, CA (US); Yung-Chung LO, San Diego, CA (US); Kyung Hwan KIM, Oceanside, CA (US); Shrenik PATEL, San Diego, CA (US); Subaash KATHIRKAMAR, Hyderabad (IN); Anoop RAMAKRISHNA, San Diego, CA (US); Hyder SHAD, San Diego, CA (US); Sriram GANESH, San Diego, CA (US)

(21) Appl. No.: 19/088,354

(22) Filed: Mar. 24, 2025

(51) Int. Cl. H04B 1/04

(52) U.S. Cl. CPC H04B 1/0475

(57) ABSTRACT

Certain aspects of the present disclosure are directed towards techniques and apparatus for wireless communication. An example apparatus generally includes a transmit chain including an intermediate frequency circuit and a radio frequency circuit and a controller configured to: detect that a gain associated with the transmit chain is to be reduced; in response to the detection, determine whether to reduce a gain of the intermediate frequency circuit or the radio frequency circuit based on an output power of the radio frequency circuit compared to one or more threshold; and reduce the gain of the intermediate frequency circuit or the radio frequency circuit in accordance with the determination.

### BACKGROUND

### Field of the Disclosure

Certain aspects of the present disclosure generally relate to electronic components and, more particularly, to techniques for gain control of a transmit chain.

### Description of Related Art

Electronic devices include computing devices such as desktop computers, notebook computers, tablet computers, smartphones, wearable devices like a smartwatch, internet servers, and so forth. These various electronic devices provide information, entertainment, social interaction, security, safety, productivity, transportation, manufacturing, and other services to human users. These various electronic devices depend on wireless communications for many of their functions. Wireless communication systems and devices are widely deployed to provide various types of communication content such as voice, video, packet data, messaging, broadcast, and so on. These systems may be capable of supporting communication with multiple users by sharing the available system resources (e.g., time, frequency, and power). Examples of such systems include code division multiple access (CDMA) systems, time division multiple access (TDMA) systems, frequency division multiple access (FDMA) systems, and orthogonal frequency division multiple access (OFDMA) systems (e.g., a Long Term Evolution (LTE) system or a New Radio (NR) system). Wireless devices may include transmitters for processing signals for transmission via antennas. The transmit chain may include an intermediate frequency integrated circuit (IFIC) and a radio frequency integrated circuit (RFIC), each including one or more mixers to generate respective intermediate frequency and radio frequency signals.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure are directed towards an apparatus for wireless communication. The apparatus generally includes a transmit chain including an intermediate frequency integrated circuit (IFIC) and a radio frequency integrated circuit (RFIC) and a controller configured to: detect that a gain associated with the transmit chain is to be reduced; in response to the detection, determine whether to reduce a gain of the IFIC or the RFIC based on an output power of the RFIC compared to one or more threshold; and reduce the gain of the IFIC or the RFIC in accordance with the determination.

Certain aspects of the present disclosure are directed towards an apparatus for wireless communication. The apparatus generally includes a transmit chain including an intermediate frequency circuit and a radio frequency circuit and a controller configured to: detect that a gain associated with the transmit chain is to be reduced; in response to the detection, determine whether to reduce a gain of the intermediate frequency circuit or the radio frequency circuit based on an output power of the radio frequency circuit compared to one or more threshold; and reduce the gain of the intermediate frequency circuit or the radio frequency circuit in accordance with the determination.

Certain aspects of the present disclosure are directed towards a method for wireless communication. The method generally includes: detecting that a gain associated with a transmit chain is to be reduced; in response to the detection, determining whether to reduce a gain of an intermediate frequency circuit of the transmit chain or an radio frequency circuit of the transmit chain based on an output power of the radio frequency circuit compared to one or more threshold; and reducing the gain of the intermediate frequency circuit or the radio frequency circuit in accordance with the determination.

Certain aspects of the present disclosure are directed towards an apparatus for wireless communication. The apparatus generally includes: memory and one or more processors coupled to the memory and configured to: detect that a gain associated with a transmit chain is to be reduced; in response to the detection, determine whether to reduce a gain of an intermediate frequency circuit of the transmit chain or an radio frequency circuit of the transmit chain based on an output power of the RFIC compared to one or more threshold; and reduce the gain of the intermediate frequency circuit or the radio frequency circuit in accordance with the determination.

Certain aspects of the present disclosure are directed toward an apparatus for wireless communication. The apparatus generally includes a transmit chain including an intermediate frequency circuit and a radio frequency circuit, and a controller configured to: detect that a gain associated with the transmit chain is to be increased; in response to the detection, determine whether to increase a gain of the intermediate frequency circuit or the radio frequency circuit based on an output power of the radio frequency circuit compared to one or more thresholds; and control an increase of the gain of the intermediate frequency circuit or the radio frequency circuit in accordance with the determination.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a diagram of an example wireless communications network, in which certain aspects of the present disclosure may be practiced.

FIG. 2 is a block diagram of an example access point (AP) and example user terminals, in which certain aspects of the present disclosure may be practiced.

FIG. 3 is a block diagram of an example transceiver front end, in which certain aspects of the present disclosure may be practiced.

FIG. 4 illustrates a wireless device including an intermediate frequency integrated circuit (IFIC) coupled to one or more radio frequency integrated circuits (RFICs).

FIG. 5 is a graph illustrating an IFIC output power spectral density (PSD).

FIG. 6 is a graph illustrating error vector magnitude (EVM) as a function of RFIC output power, in accordance with certain aspects of the present disclosure.

FIG. 7 is a graph illustrating EVM as a function of RFIC output power, in accordance with certain aspects of the present disclosure.

FIG. 8 is a flow diagram illustrating example operations for wireless communication, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed toward techniques and apparatus for adjusting a gain of a transmit chain. For example, a gain of the transmit chain may be reduced to reduce transmit power for a wireless device. In some cases, the transmit chain may include an intermediate frequency integrated circuit (IFIC) coupled to a radio frequency integrated circuit (RFIC). The gain of the RFIC may be reduced in some implementations to reduce the gain. Certain aspects of the present disclosure are directed towards techniques for adjusting the gain of the transmit chain by adjusting the gain of the RFIC and/or the gain of the IFIC, for example in a manner that reduces the overall error vector magnitude (EVM) of the transmit chain (e.g., as compared to only reducing the gain of the RFIC). For example, one or more thresholds may be defined with respect to an output power of the RFIC, where the gain of the IFIC or the RFIC is adjusted based on how the output power compares to the one or more thresholds. The one or more thresholds may be set based on one or more factors, such as a loss associated with a cable between the RFIC and the IFIC, a configured communication frequency and bandwidth, the temperature of the transmit chain, and the existence of a spur that may be caused by a clock signal, as described in more detail herein.

### EXAMPLE WIRELESS COMMUNICATIONS

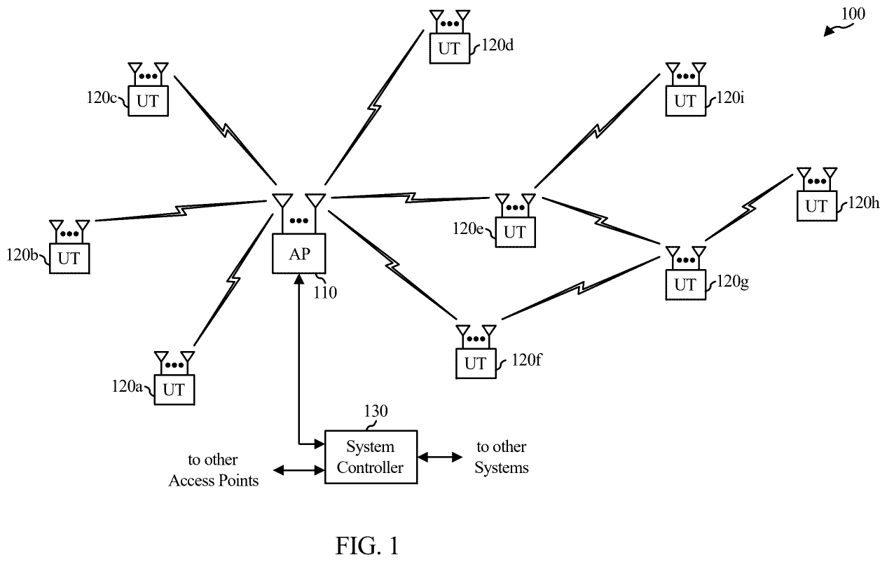

FIG. 1 illustrates a wireless communications system 100 with access points 110 and user terminals 120, in which aspects of the present disclosure may be practiced. For simplicity, only one access point 110 is shown in FIG. 1. An access point (AP) is generally a fixed station that communicates with the user terminals and may also be referred to as a base station (BS), an evolved Node B (eNB), a next generation Node B (gNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

Wireless communications system 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≥1). The Nᵤ selected user terminals can have the same or different number of antennas.

Wireless communications system 100 may be a time division duplex (TDD) system or a frequency division duplex (FDD) system. For a TDD system, the downlink and uplink share the same frequency band. For an FDD system, the downlink and uplink use different frequency bands. Wireless communications system 100 may also utilize a single carrier or multiple carriers for transmission. Each user terminal 120 may be equipped with a single antenna (e.g., to keep costs down) or multiple antennas (e.g., where the additional cost can be supported).

In some aspects, the user terminal 120 or access point 110 may include a transmit chain with an intermediate frequency integrated circuit (IFIC) coupled to a radio frequency integrated circuit (RFIC). In some aspects, a gain associated with the transmit chain may be adjusted by adjusting the gain of the RFIC and/or the IFIC based on how an output power of the RFIC compares to one or more thresholds, as described in more detail herein.

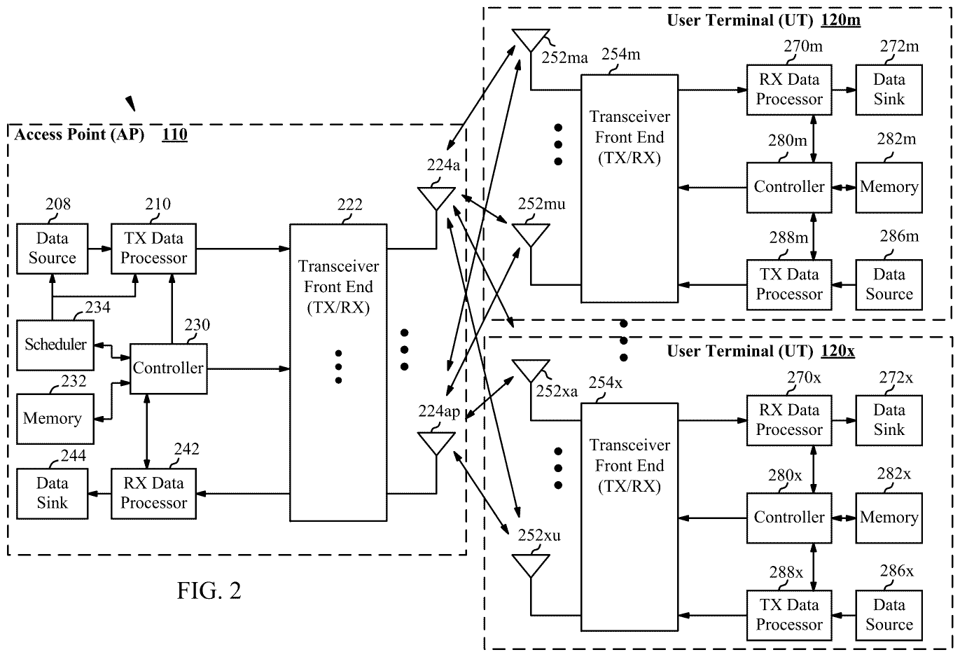

FIG. 2 shows a block diagram of access point 110 and two user terminals 120m and 120x in the wireless communications system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering, beamforming, or some other spatial processing technique may be used at the access point and/or user terminal.

On the uplink, at each user terminal 120 selected for uplink transmission, a transmitter (TX) data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ}for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the N_{ut,m} antennas for transmit diversity via an RF switch, for example. The controller 280 may control the routing within the transceiver front end 254. Memory 282 may store data and program codes for the user terminal 120 and may interface with the controller 280.

A number Nᵤₚ of user terminals 120 may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one of the antennas 224 for processing. The signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal. A receiver (RX) data processor 242 processes (e.g., demodulates, deinterleaves, and decodes) the recovered uplink data symbol stream in accordance with the rate used for that stream to obtain decoded data. The decoded data for each user terminal may be provided to a data sink 244 (e.g., corresponding to data sink 272 of UT) for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222. Memory 232 may store data and program codes for the access point 110 and may interface with the controller 230.

At each user terminal 120, N_{ut,m} antennas 252 receive the downlink signals from access point 110. For receive diversity at the user terminal 120, the transceiver front end 254 may select signals received from one or more of the antennas 252 for processing. The signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

In some aspects, the transceiver front end 254 or 222 may include a transmit chain with an IFIC coupled to an RFIC. In some aspects, a gain associated with the transmit chain may be adjusted by adjusting the gain of the RFIC and/or the IFIC based on how an output power of the RFIC compares to one or more thresholds, as described in more detail herein.

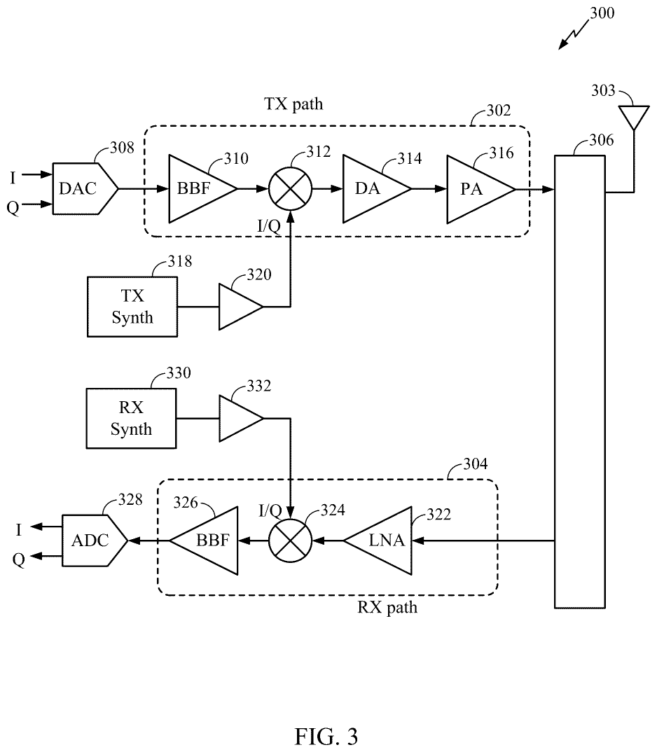

FIG. 3 is a block diagram of an example transceiver front end 300, such as transceiver front ends 222, 254 in FIG. 2, in which aspects of the present disclosure may be practiced. The transceiver front end 300 includes at least one transmit (TX) path 302 (also known as a transmit chain) for transmitting signals via one or more antennas and at least one receive (RX) path 304 (also known as a receive chain) for receiving signals via the one or more antennas. When the TX path 302 and the RX path 304 share an antenna 303, the paths may be connected with the antenna via an interface 306, which may include any of various suitable RF devices, such as a switch, a duplexer, a diplexer, a multiplexer, and the like.

Receiving in-phase (I) or quadrature (Q) baseband analog signals from a digital-to-analog converter (DAC) 308, the TX path 302 may include a baseband filter (BBF) 310, a mixer 312, a driver amplifier (DA) 314, and a power amplifier (PA) 316. In some cases, the DA 314 may include a pre-DA that may drive a DA, where the DA drives the PA 316. The BBF 310, the mixer 312, the DA 314, and the PA 316 may be implemented in multiple chips or integrated circuits.

The BBF 310 filters the baseband signals received from the DAC 308, and the mixer 312 mixes the filtered baseband signals with a transmit local oscillator (LO) signal to convert the baseband signal of interest to a different frequency (e.g., upconvert from baseband to RF). This frequency-conversion process produces the sum and difference frequencies of the LO frequency and the frequencies of the baseband signal of interest. The sum and difference frequencies are referred to as the beat frequencies. The beat frequencies are typically in the RF range, such that the signals output by the mixer 312 are typically RF signals, which may be amplified by the DA 314 and/or by the PA 316 before transmission by the antenna 303. While one mixer 312 is illustrated, several mixers may be used to upconvert the filtered baseband signals to one or more intermediate frequencies and to thereafter upconvert the intermediate frequency (IF) signals to a frequency for transmission. Such mixers may be implemented in separate chips or integrated circuits, for example in an IFIC and an RFIC, as described further below.

The RX path 304 includes a low noise amplifier (LNA) 322, a mixer 324, and a baseband filter (BBF) 326. The LNA 322, the mixer 324, and the BBF 326 may be implemented in multiple chips or ICs, which may or may not be the same chips or ICs that include the TX path components. RF signals received via the antenna 303 may be amplified by the LNA 322, and the mixer 324 mixes the amplified RF signals with a receive local oscillator (LO) signal to convert the RF signal of interest to a different baseband frequency (e.g., downconvert). While one mixer 324 is illustrated, several mixers may be used to downconvert the amplified RF signals to one or more intermediate frequencies and to thereafter downconvert the intermediate frequency (IF) signals to baseband signals. Such mixers may be implemented in separate chips or integrated circuits, for example in an RFIC and an IFIC. The baseband signals output by the mixer 324 may be filtered by the BBF 326 before being converted by an analog-to-digital converter (ADC) 328 to digital I and/or Q signals for digital signal processing.

Certain transceivers may employ a variable-frequency oscillator (e.g., a voltage-controlled oscillator (VCO) or a digitally controlled oscillator (DCO)) to generate a stable, tunable LO signal with a particular tuning range. Thus, the transmit LO signal may be produced by a TX frequency synthesizer 318, which may be buffered or amplified by amplifier 320 before being mixed with the baseband signals in the mixer 312. Similarly, the receive LO signal may be produced by an RX frequency synthesizer 330, which may be buffered or amplified by amplifier 332 before being mixed with the RF signals in the mixer 324. For certain aspects, a single frequency synthesizer may be used for both the TX path 302 and the RX path 304.

In certain aspects, the transceiver front end 300 may include a transmit chain with an IFIC coupled to an RFIC (e.g., via a cable). The RFIC may include a subset of components in the TX path 302 described with respect to FIG. 3, such as one or more of the mixers 312, the DA 314, and the PA 316, and the IFIC may include another subset of components in the TX path 302, such as the DAC 308, the BBF 310, and one or more of the mixers 312. It will be understood that the TX path 302 may include components in addition to those illustrated, such as multiple mixers, one or more filters and/or amplifiers in series between the multiple mixers, a cable or routing coupling elements together, such as when those elements are implemented in different ICs, etc. In some aspects, a gain associated with the transmit chain may be adjusted by adjusting the gain of the RFIC and/or the IFIC based on how an output power of the RFIC compares to one or more thresholds, as described in more detail herein.

While FIGS. 1-3 provide wireless communications as an example application in which certain aspects of the present disclosure may be implemented to facilitate understanding, certain aspects described herein may be used in any of various other suitable systems.

### EXAMPLE TECHNIQUES FOR GAIN CONTROL

Gain control may be used to support the dynamic range of certain wireless technologies (e.g., millimeter wave technology) from a maximum power (Pmax) setting to a minimum power (Pmin) setting. Some technologies use a heterodyne architecture where an intermediate frequency circuit serves one or more radio frequency circuits. In some aspects, the intermediate frequency circuit may be part of an intermediate frequency integrated circuit (IFIC) and each radio frequency circuit may be part of a respective radio frequency integrated circuit (RFIC). While some examples provided herein are described with respect an IFIC and an RFIC, the aspects of the present disclosure can be applied for any intermediate frequency circuit or radio frequency circuit.

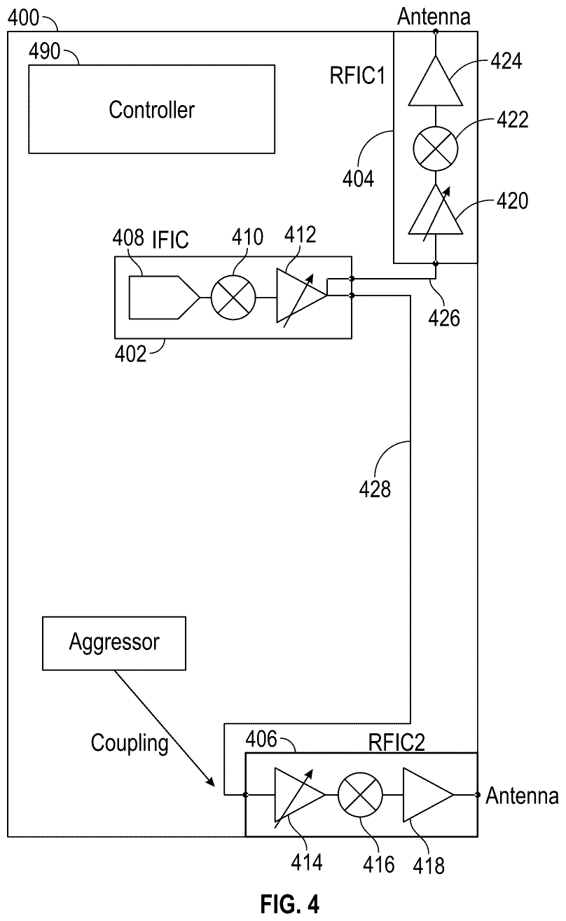

FIG. 4 illustrates a wireless device 400 including an IFIC 402 coupled to RFICs 404, 406 via respective cables 426, 428. As shown, the IFIC 402 may include a DAC 408 for converting a digital signal to an analog signal, where an output of the DAC 408 is coupled to an input of a mixer 410. The mixer 410 upconverts the analog signal from the DAC 408 to generate an upconverted signal at the intermediate frequency (IF) that may be provided to an amplifier 412 for amplification. One or more filters, not illustrated, may also be included in the IFIC 402). The amplified signal from the amplifier 412 may be provided to the RFICs 404, 406 for further processing and transmission, depending on which RFIC is enabled for transmission.

RFIC 404 (labeled “RFIC1”) may include an amplifier 420 to further amplify the signal from the IFIC 402. The output of the amplifier 420 may be provided to a mixer 422 to upconvert the signal from the amplifier 420 and generate a radio frequency (RF) signal (also referred to as “transmission frequency signal”). The RF signal is then provided to an amplifier 424 (e.g., a power amplifier (PA)) for amplification before transmission via an antenna. Similarly, RFIC 406 (labeled “RFIC2”) may include an amplifier 414 to amplify the signal from the IFIC 402. The output of the amplifier 414 may be provided to a mixer 416 to upconvert the signal from the amplifier 414 and generate an RF signal to be provided to an amplifier 418 (e.g., a PA) for amplification before transmission via an antenna. While two RFICs (e.g., RFICs 404, 406) are illustrated in FIG. 4, a fewer (e.g., one) or greater (e.g., three or more) quantity of RFICs may be included in the wireless device 400. One or more of the RFICs may be coupled to a respective IFIC, and/or one or more of the RFICs may be coupled to a common IC (e.g., as illustrated in FIG. 4).

As shown, the IFIC 402 may be coupled to RFICs 404, 406 using respective cables 426, 428. The RFIC 404 may be closer to the IFIC 402 than RFIC 406. Thus, the length of cable 426 may be shorter than the length of cable 428. As a result, the total impedance (e.g., resistance) of the cable 428 may be greater than the impedance of the cable 426, resulting in greater power losses when providing signals from the IFIC to the RFIC 406 as compared to providing signals to the RFIC 404. In some aspects of the present disclosure, losses associated with a cable between the IFIC and the RFIC may be considered along with other factors for gain control, as described in more detail herein.

In some aspects, the wireless device 400 may include a controller 490 that may be used to adjust the gain of a transmit chain, such as a chain including the IFIC 402 and RFIC 404 or a chain including the IFIC 402 and RFIC 406. For example, the gain of the transmit chain may be adjusted to adjust the transmit power of a transmission. As described in more detail herein, to adjust the gain, the gain of one or more amplifiers of the transmit chain may be adjusted, such as the gain of at least one of amplifiers 412, 414, 418, 420, 424.

In some scenarios, the gain of the RFIC may be kept low to avoid amplifying aggressor signals that may couple to the input of the RFIC. These aggressor signals may be signals from other transmitters that may be near the RFIC. For example, through coupling via a printed circuit board (PCB) or other substrate on which the IFIC and RFICs are disposed, an aggressor signal may leak to the input of the RFIC (e.g., RFIC 406) and be amplified by the RFIC, becoming an emission as part of the transmission. Keeping the gain of the RFIC low mitigates (or at least reduces) this leakage emission. RFIC gain is equal to the output power of the RFIC minus the input power of the RFIC. The output power of the RFIC may be held constant (for a given scenario) by design (e.g., according to a designated transmit power limit for the transmit chain, which may be based on RF exposure compliance). Thus, increasing the input power of the RFIC (e.g., by increasing the IFIC output power) may allow for the RFIC gain to be lowered. However, keeping a high IFIC output power or gain may cause error vector magnitude (EVM) degradation.

A high IFIC output power may be used when operating at maximum power at the antenna (e.g., providing maximum transmission power). When backing off antenna power, input power may be relaxed one level (e.g., 1 dB) at a time. The EVM at the output of the IFIC may vary with different analog and digital settings (e.g., of the analog amplifiers in the transmit chain and of digital components, such as in a digital predistortion (DPD) block which may be included in a modem, controller, or other processor). While high IFIC output power helps to reduce aggressor signal emission (e.g., by allowing the RFIC gain to be reduced), high IFIC gain to increase IFIC output power may result in increased EVM due to non-linearity. In some cases, high IFIC output power may be used when operating with maximum power at the antenna. Otherwise, the IFIC power may be reduced to improve EVM. However, EVM does not always improve in response to reducing IFIC output power because, below a certain power threshold, EVM is more driven (e.g., influenced) by thermal noise. For instance, when operating with a 12.5 dB analog gain for the IFIC in certain configurations or scenarios, reducing power reduces EVM. However, when operating with a 4.5 dB analog gain for the IFIC in those configurations or scenarios, reducing IFIC output power may have little impact on EVM. With 0.5 dB analog gain for the IFIC in such example configurations or scenarios, reducing IFIC output power may even increase EVM.

Performance in terms of metrics such as EVM may be a function of bandwidth, temperature, frequency, and/or process variations. Analog gain may be used to compensate (or at least adjust) for different cable losses. For example, the longer the cable between the IFIC and the RFIC, the higher the cable loss may be between the IFIC and the RFIC, as described. Thus, a higher analog gain in the IFIC may be used to maintain the same power level at the input of the RFIC.

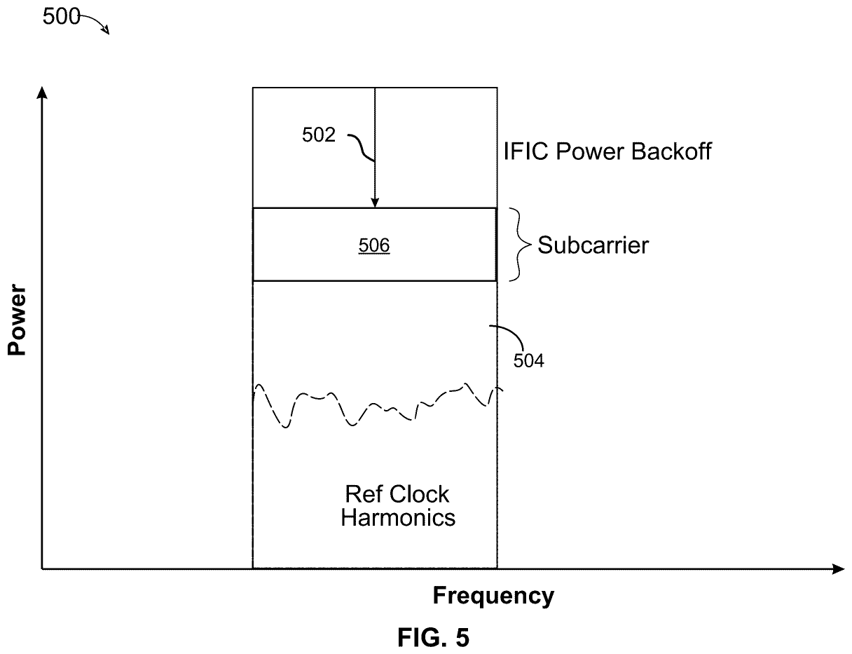

FIG. 5 is a graph 500 illustrating an IFIC output power spectral density (PSD). The gain of the IFIC may be reduced to reduce the power (e.g., back off the power) of the IF signal. In some cases, a lower limit may exist of how far the IFIC gain can be reduced (e.g., as represented by arrow 502) due to the existence of a spur. For example, a spur may be caused by one or more harmonics of a reference clock signal for the wireless device. The spur caused by one or more harmonics of the reference clock signal may interfere with a subcarrier 506 having a power up to a certain power threshold, causing a transmission's block error rate (BLER) for the subcarrier to no longer meet specifications. The spur may be coupled to an output of the IFIC. Thus, if the IFIC gain is reduced beyond a certain threshold such that the subcarrier 506 is within a power range 504, the transmission's BLER may increase and no longer meet specifications. That is, there may be a lower limit with regard to how low the IFIC gain can be reduced such that the power of the subcarrier 506 is above the power threshold at which the BLER of the transmission no longer meets specifications. The IFIC gain may be reduced to maintain a reduced (e.g., minimum) decibels relative to the carrier (dBc) or subcarrier power level.

It may be better to lower the RFIC gain in certain scenarios as compared to the IFIC gain. For example, for a specific RFIC design, the EVM of the RFIC may be lowest when operating with a gain at a certain target gain. If the RFIC gain is above the target gain, it may be beneficial to reduce the RFIC gain to reduce EVM. As another example, digital predistortion (DPD) may be performed to increase the overall linearity of the transmit chain. The DPD may be performed for a specific IFIC gain. Therefore, it may be desirable to keep the IFIC gain the same (e.g., or within a range of a gain for which DPD is trained) to maintain the linearity of the IFIC. Thus, the RFIC gain may be reduced in some cases instead of the IFIC gain to maintain the IFIC gain that may be within the range of the gain used for DPD training.

Certain aspects of the present disclosure provide a multi-range mixed gain control technique, considering the various factors described herein. In some aspects, instead of always reducing the RFIC gain when transmit power is to be reduced, either the gain of the RFIC or the IFIC may be reduced depending on the current operating condition of the wireless device, as described in more detail herein.

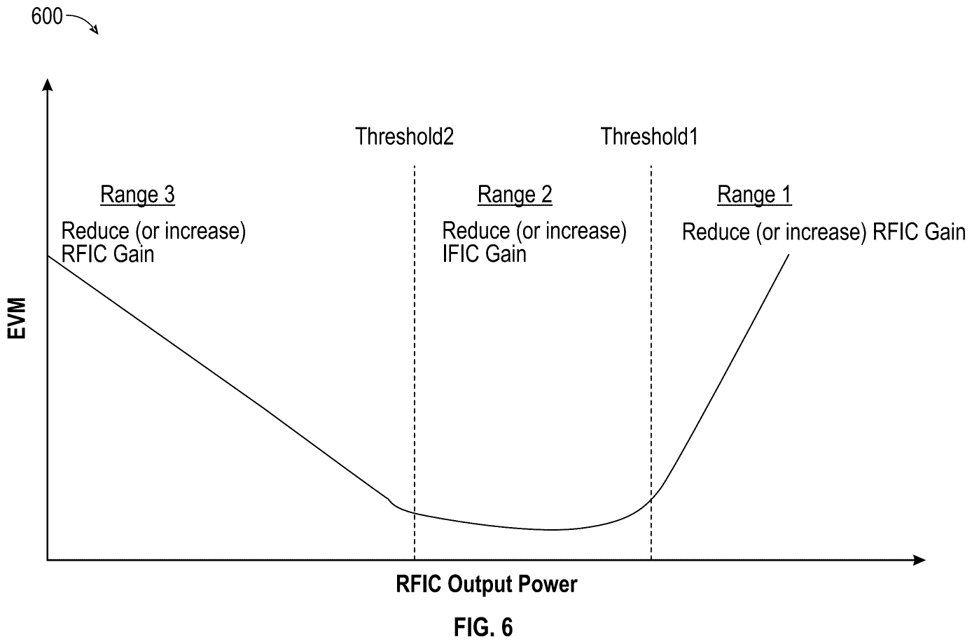

FIG. 6 is a graph 600 illustrating EVM as a function of RFIC output power, in accordance with certain aspects of the present disclosure. In some aspects, three different RF output power ranges may be configured, including a first range labeled “Range 1” that is greater than a first threshold labeled “Threshold1,” a second range labeled “Range 2” that is between threshold 1 and a second threshold labeled “Threshold2,” and a third range labeled “Range 3” that is less than threshold 2.

If the RFIC output power is within range 1, the RFIC gain may be reduced to keep the same IFIC output power used for DPD training to maintain the transmit chain linearity. Moreover, within range 1, the impact on the EVM may be dominated by the gain of the RFIC. Thus, backing off the IFIC power may provide little to no overall improvement of EVM. If the RFIC output power is within range 2 (e.g., between threshold 1 and threshold 2), the IFIC gain may be reduced since reducing the IFIC gain improves the IFIC EVM, improving the overall EVM of the wireless device. If the RFIC output power is within range 3, the RFIC gain may be reduced in order to obtain potential RFIC EVM improvement with gain reduction.

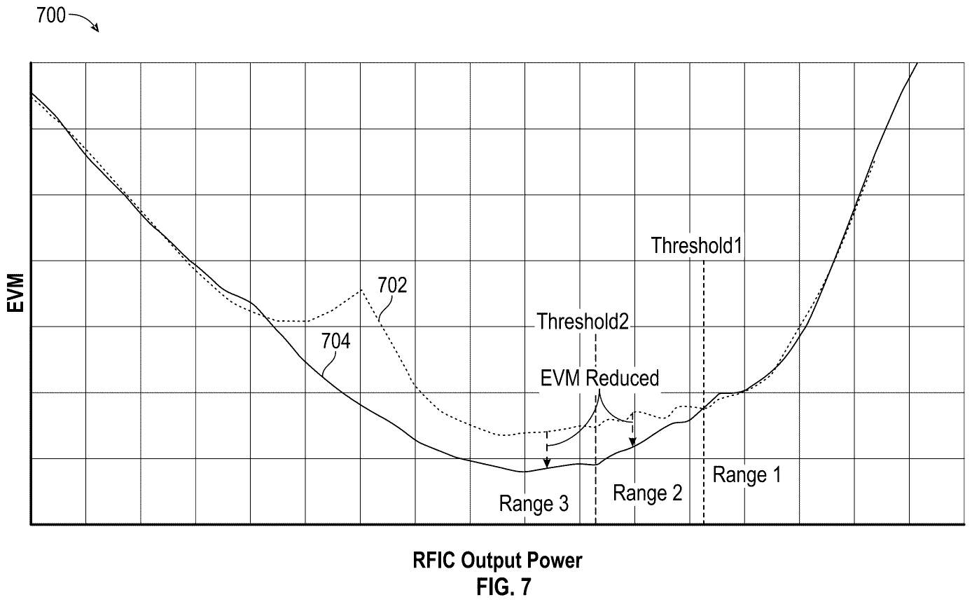

FIG. 7 is a graph 700 illustrating EVM as a function of RFIC output power when reducing only RFIC gain as compared to when reducing RFIC and IFIC gains, in accordance with certain aspects of the present disclosure. The curve 702 shows the EVM when only reducing the RFIC gain, and the curve 704 shows the EVM when reducing both the RFIC and IFIC gain as described herein. When the output power of the RFIC is within range 2, by reducing the IFIC gain as opposed to reducing the RFIC gain, the EVM may be further decreased as shown.

While techniques for reducing output power have been described to reduce EVM, similar techniques may be used to increase the RFIC output power. For example, if the output power of the RFIC is within range 3, the RFIC gain may be increased to increase the RFIC output power until the RFIC output power reaches threshold 2. If the RFIC output power is within range 2, the IFIC gain may be increased to increase RFIC output power until the RFIC output power reaches threshold 1. If the RFIC output power is within range 1, the RFIC gain may be increased to increase the RFIC output power.

In some aspects, the IFIC and RFIC gains associated with a specific target RFIC output power may be characterized and stored in memory (e.g., as part of a lookup table). When adjusting RFIC output power, the wireless device may identify the associated IFIC and RFIC gains from memory and set the gains accordingly. In some cases, different lookup tables may be stored in memory, where the lookup tables are associated with different operating conditions, such as temperature, bandwidth, or frequency, as described in more detail herein.

Certain aspects of the present disclosure are directed towards techniques for determining threshold 1 and threshold 2, defining the three ranges described herein. In some aspects, as the loss of the cable between the IFIC and the RFIC increases, the difference between threshold 1 and threshold 2 may be increased. For example, threshold 2 may be decreased, expanding range 2 where the IFIC grain is reduced. As shown in FIG. 4, cable 426 may be shorter than cable 428. Thus, the loss associated with cable 428 may be more than the loss associated with cable 426. As a result, when using cable 428 for communication via RFIC 406, threshold 2 may be reduced to expand range 2.

In some cases, the ranges described herein may be configured based on the operating bandwidth of the wireless device. Using a wider bandwidth may result in increased thermal noise. Therefore, range 2 may be expanded by decreasing threshold 2 when using a wider bandwidth. Threshold 1 may be set as a function of the RF frequency since the RF frequency sets the saturation power (Psat) of the PA of the RFIC that is used as part of the DPD training for the RFIC to increase linearity. On the other hand, threshold 2 may be adjusted based on the intermediate frequency. A higher intermediate frequency may result in more losses for the IFIC. Therefore, threshold 2 may be reduced to increase the IFIC power back off. In some aspects, the ranges described herein may be set as a function of temperature. For example, in response to increasing temperatures resulting in increased thermal noise, range 2 may be expanded by decreasing threshold 2. As described herein, a spur level that may couple to the RFIC input may set a lower limit for threshold 2 (e.g., a lower limit for the gain of the IFIC).

While the various factors that impact the thresholds have been described individually to facilitate understanding, the thresholds may be set using testing across a combination of conditions. For example, a device may be tested (e.g., in a factory) under different conditions (e.g., with different temperatures, cable losses, bandwidths, and frequencies) with measurements of EVM for each condition. Based on the measurements, the thresholds may be identified for the different conditions and stored in memory as threshold configurations (e.g., stored as a lookup table). During operation, the thresholds may be set using the threshold configurations in memory (e.g., in a lookup table) as mapped to a particular condition of the wireless device. For example, if the temperature, bandwidth, and frequency are within respective ranges as identified in the lookup table, the associated thresholds may be identified from the table.

In some cases, instead of storing the thresholds for the different conditions in lookup tables, the thresholds may be identified, and the associated mappings between a target RFIC output power and RFIC/IFIC gains may be stored in lookup tables for the different conditions. For a particular condition during operation (e.g., for particular ranges of temperature, bandwidth, and frequency), one of the lookup tables may be used to identify the RFIC/IFIC gains to be used for a target RFIC output power.

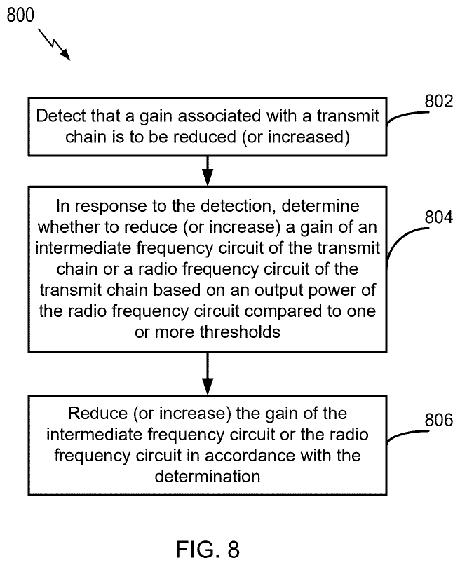

FIG. 8 is a flow diagram illustrating example operations 800 for wireless communication, in accordance with certain aspects of the present disclosure. The operations 800 may be performed, for example, by a wireless device, such as the wireless device 400.

At block 802, the wireless device may detect that a gain associated with a transmit chain is to be reduced (or increased). At block 804, the wireless device may, in response to the detection, determine whether to reduce (or increase) a gain of an intermediate frequency circuit (e.g., IFIC 402) of the transmit chain or a radio frequency circuit (e.g., RFIC 404 or RFIC 406) of the transmit chain based on an output power of the radio frequency circuit compared to one or more thresholds. At block 806, the wireless device may reduce (or increase) the gain of the intermediate frequency circuit or the radio frequency circuit in accordance with the determination.

In some aspects, the one or more thresholds may include a first threshold (e.g., threshold 1 of FIG. 6). Reducing (or increasing) the gain may include: reducing (or increasing) the gain of the radio frequency circuit if the output power is greater than or equal to the first threshold; or reducing (or increasing) the gain of the intermediate frequency circuit if the output power is less than the first threshold. In some aspects, the one or more thresholds include a second threshold (e.g., threshold 2 of FIG. 6). To reduce (or increase) the gain, the wireless device may reduce (or increase) the gain of the radio frequency circuit if the output power is less than the second threshold. In some aspects, the gain of the intermediate frequency circuit is reduced to decrease an error vector magnitude (EVM) of the wireless device.

In some aspects, reducing (or increasing) the gain may include: reducing (or increasing) the gain of the radio frequency circuit if the output power is less than a threshold (e.g., threshold 2 of FIG. 6) of the one or more thresholds; or reducing (or increasing) the gain of the intermediate frequency circuit if the output power is equal to or greater than the threshold. A lower limit associated with the threshold may be set based on a spur caused by a clock signal, for example.

In some aspects, the one or more thresholds may include thresholds defining a range (e.g., range 2 of FIG. 6) of the output power of the radio frequency circuit. To reduce (or increase) the gain, the wireless device may reduce (or increase) the gain of the intermediate frequency circuit if the output power is within the range. In some aspects, the wireless device may expand the range in response to at least one of: a higher amount of loss associated with a cable between the intermediate frequency circuit and the radio frequency circuit; a wider bandwidth associated with communication via the radio frequency circuit; a higher intermediate frequency associated with the intermediate frequency circuit; or a higher temperature associated with an apparatus including the intermediate frequency circuit or radio frequency circuit.

In some aspects, the wireless device may set the one or more thresholds based on at least one of: amount of loss associated with a cable between the intermediate frequency circuit and the radio frequency circuit; a bandwidth associated with communication via the radio frequency circuit; a radio frequency associated with the radio frequency circuit; an intermediate frequency associated with the intermediate frequency circuit; a temperature associated with an apparatus including the intermediate frequency circuit or radio frequency circuit; or a spur caused by a clock signal.

### EXAMPLE ASPECTS

Aspect 1: An apparatus for wireless communication, comprising: a transmit chain including an intermediate frequency circuit and a radio frequency circuit; and a controller configured to: detect that a gain associated with the transmit chain is to be reduced; in response to the detection, determine whether to reduce a gain of the intermediate frequency circuit or the radio frequency circuit based on an output power of the radio frequency circuit compared to one or more thresholds; and control reduction of the gain of the intermediate frequency circuit or the radio frequency circuit in accordance with the determination.

Aspect 2: The apparatus of Aspect 1, wherein the one or more thresholds include a first threshold, and wherein, to reduce the gain, the controller is configured to: control reduction of the gain of the radio frequency circuit if the output power is greater than or equal to the first threshold; or control reduction of the gain of the intermediate frequency circuit if the output power is less than the first threshold.

Aspect 3: The apparatus of Aspect 2, wherein: the one or more thresholds include a second threshold; and to reduce the gain, the controller is configured to control reduction of the gain of the radio frequency circuit if the output power is less than the second threshold.

Aspect 4: The apparatus of Aspect 3, wherein the controller is configured to control reduction of the gain of the radio frequency circuit to decrease an error vector magnitude (EVM) associated with the apparatus.

Aspect 5: The apparatus according to any of Aspects 1-4, wherein, to reduce the gain, the controller is configured to: control reduction of the gain of the radio frequency circuit if the output power is less than a threshold of the one or more thresholds; or control reduction of the gain of the intermediate frequency circuit if the output power is equal to or greater than the threshold.

Aspect 6: The apparatus of Aspect 5, wherein a lower limit associated with the threshold is set based on a spur caused by a clock signal of the apparatus.

Aspect 7: The apparatus according to any of Aspects 1-6, wherein the one or more thresholds include thresholds defining a range of the output power of the radio frequency circuit, and wherein, to reduce the gain, the controller is configured to control reduction of the gain of the intermediate frequency circuit if the output power is within the range.

Aspect 8: The apparatus of Aspect 7, wherein the controller is configured to expand the range in response to at least one of: a higher amount of loss associated with a cable between the intermediate frequency circuit and the radio frequency circuit; a wider bandwidth associated with communication via the radio frequency circuit; a higher intermediate frequency associated with the intermediate frequency circuit; or a higher temperature associated with the apparatus.

Aspect 9: The apparatus according to any of Aspects 1-8, wherein the controller is configured to set the one or more thresholds based on at least one of: an amount of loss associated with a cable between the intermediate frequency circuit and the radio frequency circuit; a bandwidth associated with communication via the radio frequency circuit; a radio frequency associated with the radio frequency circuit; an intermediate frequency associated with the intermediate frequency circuit; a temperature associated with the apparatus; or a spur caused by a clock signal of the apparatus.

Aspect 10: The apparatus according to any of Aspects 1-9, wherein, to reduce the gain, the controller is configured to control reduction of one or more gains associated with one or more amplifiers of the intermediate frequency circuit or the radio frequency circuit.

Aspect 11: A method for wireless communication, comprising: detecting that a gain associated with a transmit chain is to be reduced; in response to the detection, determining whether to reduce a gain of an intermediate frequency circuit of the transmit chain or a radio frequency circuit of the transmit chain based on an output power of the radio frequency circuit compared to one or more thresholds; and reducing the gain of the intermediate frequency circuit or the radio frequency circuit in accordance with the determination.

Aspect 12: The method of Aspect 11, wherein the one or more thresholds include a first threshold, and wherein reducing the gain includes: reducing the gain of the radio frequency circuit if the output power is greater than or equal to the first threshold; or reducing the gain of the intermediate frequency circuit if the output power is less than the first threshold.

Aspect 13: The method of Aspect 12, wherein: the one or more thresholds further include a second threshold; and reducing the gain includes reducing the gain of the radio frequency circuit if the output power is less than the second threshold.

Aspect 14: The method of Aspect 13, wherein the gain of the radio frequency circuit is reduced to decrease an error vector magnitude (EVM).

Aspect 15: The method according to any of Aspects 11-14, wherein reducing the gain includes: reducing the gain of the radio frequency circuit if the output power is less than a threshold of the one or more thresholds; and reducing the gain of the intermediate frequency circuit if the output power is equal to or greater than the threshold.

Aspect 16: The method of Aspect 15, wherein a lower limit associated with the threshold is set based on a spur caused by a clock signal.

Aspect 17: The method according to any of Aspects 11-16, wherein: the one or more thresholds include thresholds defining a range of the output power of the radio frequency circuit; and reducing the gain includes reducing the gain of the intermediate frequency circuit if the output power is within the range.

Aspect 18: The method of Aspect 17, further comprising expanding the range in response to at least one of: a higher amount of loss associated with a cable between the intermediate frequency circuit and the radio frequency circuit; a wider bandwidth associated with communication via the radio frequency circuit; a higher intermediate frequency associated with the intermediate frequency circuit; or a higher temperature associated with an apparatus including the intermediate frequency circuit or radio frequency circuit.

Aspect 19: The method according to any of Aspects 11-18, further comprising setting the one or more thresholds based on at least one of: an amount of loss associated with a cable between the intermediate frequency circuit and the radio frequency circuit; a bandwidth associated with communication via the radio frequency circuit; a radio frequency associated with the radio frequency circuit; an intermediate frequency associated with the intermediate frequency circuit; a temperature associated with an apparatus including the intermediate frequency circuit or radio frequency circuit; or a spur caused by a clock signal.

Aspect 20: An apparatus for wireless communication, comprising: a transmit chain including an intermediate frequency circuit and a radio frequency circuit; and a controller configured to: detect that a gain associated with the transmit chain is to be increased; in response to the detection, determine whether to increase a gain of the intermediate frequency circuit or the radio frequency circuit based on an output power of the radio frequency circuit compared to one or more thresholds; and control an increase of the gain of the intermediate frequency circuit or the radio frequency circuit in accordance with the determination.

Aspect 21: The apparatus of Aspect 20, wherein the one or more thresholds include a first threshold, and wherein, to increase the gain, the controller is configured to: control the increase of the gain of the radio frequency circuit if the output power is greater than or equal to the first threshold; or control the increase of the gain of the intermediate frequency circuit if the output power is less than the first threshold.

Aspect 22: The apparatus of Aspect 21, wherein: the one or more thresholds include a second threshold; and to increase the gain, the controller is configured to control the increase of the gain of the radio frequency circuit if the output power is less than the second threshold.

Aspect 23: The apparatus according to any of Aspects 20-22, wherein, to increase the gain, the controller is configured to: control the increase of the gain of the radio frequency circuit if the output power is less than a threshold of the one or more thresholds; or control the increase of the gain of the intermediate frequency circuit if the output power is equal to or greater than the threshold.

Aspect 24: The apparatus of Aspect 23, wherein a lower limit associated with the threshold is set based on a spur caused by a clock signal of the apparatus.

Aspect 25: The apparatus according to any of Aspects 20-24, wherein the one or more thresholds include thresholds defining a range of the output power of the radio frequency circuit, and wherein, to increase the gain, the controller is configured to control the increase of the gain of the intermediate frequency circuit if the output power is within the range.

Aspect 26: The apparatus of Aspect 25, wherein the controller is configured to expand the range in response to at least one of: a higher amount of loss associated with a cable between the intermediate frequency circuit and the radio frequency circuit; a wider bandwidth associated with communication via the radio frequency circuit; a higher intermediate frequency associated with the intermediate frequency circuit; or a higher temperature associated with the apparatus.

Aspect 27: The apparatus according to any of Aspects 20-26, wherein the controller is configured to set the one or more thresholds based on at least one of: an amount of loss associated with a cable between the intermediate frequency circuit and the radio frequency circuit; a bandwidth associated with communication via the radio frequency circuit; a radio frequency associated with the radio frequency circuit; an intermediate frequency associated with the intermediate frequency circuit; a temperature associated with the apparatus; or a spur caused by a clock signal of the apparatus.

Aspect 28: The apparatus according to any of Aspects 20-27, wherein, to increase the gain, the controller is configured to control an increase of one or more gains associated with one or more amplifiers of the intermediate frequency circuit or the radio frequency circuit.

### ADDITIONAL CONSIDERATIONS

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a transmit chain including an intermediate frequency circuit and a radio frequency circuit; and
a controller configured to:
detect that a gain associated with the transmit chain is to be reduced;
in response to the detection, determine whether to reduce a gain of the intermediate frequency circuit or the radio frequency circuit based on an output power of the radio frequency circuit compared to one or more thresholds; and
control reduction of the gain of the intermediate frequency circuit or the radio frequency circuit in accordance with the determination.

2. The apparatus of claim 1, wherein the one or more thresholds include a first threshold, and wherein, to reduce the gain, the controller is configured to:
control reduction of the gain of the radio frequency circuit if the output power is greater than or equal to the first threshold; or
control reduction of the gain of the intermediate frequency circuit if the output power is less than the first threshold.

3. The apparatus of claim 2, wherein:
the one or more thresholds include a second threshold; and
to reduce the gain, the controller is configured to control reduction of the gain of the radio frequency circuit if the output power is less than the second threshold.

4. The apparatus of claim 3, wherein the controller is configured to control reduction of the gain of the radio frequency circuit to decrease an error vector magnitude (EVM) associated with the apparatus.

5. The apparatus of claim 1, wherein, to reduce the gain, the controller is configured to:
control reduction of the gain of the radio frequency circuit if the output power is less than a threshold of the one or more thresholds; or
control reduction of the gain of the intermediate frequency circuit if the output power is equal to or greater than the threshold.

6. The apparatus of claim 5, wherein a lower limit associated with the threshold is set based on a spur caused by a clock signal of the apparatus.

7. The apparatus of claim 1, wherein the one or more thresholds include thresholds defining a range of the output power of the radio frequency circuit, and wherein, to reduce the gain, the controller is configured to control reduction of the gain of the intermediate frequency circuit if the output power is within the range.

8. The apparatus of claim 7, wherein the controller is configured to expand the range in response to at least one of:
a higher amount of loss associated with a cable between the intermediate frequency circuit and the radio frequency circuit;
a wider bandwidth associated with communication via the radio frequency circuit;
a higher intermediate frequency associated with the intermediate frequency circuit; or
a higher temperature associated with the apparatus.

9. The apparatus of claim 1, wherein the controller is configured to set the one or more thresholds based on at least one of:
an amount of loss associated with a cable between the intermediate frequency circuit and the radio frequency circuit;
a bandwidth associated with communication via the radio frequency circuit;
a radio frequency associated with the radio frequency circuit;
an intermediate frequency associated with the intermediate frequency circuit;
a temperature associated with the apparatus; or
a spur caused by a clock signal of the apparatus.

10. The apparatus of claim 1, wherein, to reduce the gain, the controller is configured to control reduction of one or more gains associated with one or more amplifiers of the intermediate frequency circuit or the radio frequency circuit.

11. A method for wireless communication, comprising:
detecting that a gain associated with a transmit chain is to be reduced;
in response to the detection, determining whether to reduce a gain of an intermediate frequency circuit of the transmit chain or a radio frequency circuit of the transmit chain based on an output power of the radio frequency circuit compared to one or more thresholds; and
reducing the gain of the intermediate frequency circuit or the radio frequency circuit in accordance with the determination.

12. The method of claim 11, wherein the one or more thresholds include a first threshold, and wherein reducing the gain includes:
reducing the gain of the radio frequency circuit if the output power is greater than or equal to the first threshold; or
reducing the gain of the intermediate frequency circuit if the output power is less than the first threshold.

13. The method of claim 12, wherein:
the one or more thresholds further include a second threshold; and
reducing the gain includes reducing the gain of the radio frequency circuit if the output power is less than the second threshold.

14. The method of claim 13, wherein the gain of the radio frequency circuit is reduced to decrease an error vector magnitude (EVM).

15. The method of claim 11, wherein reducing the gain includes:
reducing the gain of the radio frequency circuit if the output power is less than a threshold of the one or more thresholds; and
reducing the gain of the intermediate frequency circuit if the output power is equal to or greater than the threshold.

16. The method of claim 15, wherein a lower limit associated with the threshold is set based on a spur caused by a clock signal.

17. The method of claim 11, wherein:
the one or more thresholds include thresholds defining a range of the output power of the radio frequency circuit; and
reducing the gain includes reducing the gain of the intermediate frequency circuit if the output power is within the range.

18. The method of claim 17, further comprising expanding the range in response to at least one of:
a higher amount of loss associated with a cable between the intermediate frequency circuit and the radio frequency circuit;
a wider bandwidth associated with communication via the radio frequency circuit;
a higher intermediate frequency associated with the intermediate frequency circuit; or
a higher temperature associated with an apparatus including the intermediate frequency circuit or radio frequency circuit.

19. The method of claim 11, further comprising setting the one or more thresholds based on at least one of:
an amount of loss associated with a cable between the intermediate frequency circuit and the radio frequency circuit;
a bandwidth associated with communication via the radio frequency circuit;
a radio frequency associated with the radio frequency circuit;
an intermediate frequency associated with the intermediate frequency circuit;
a temperature associated with an apparatus including the intermediate frequency circuit or radio frequency circuit; or
a spur caused by a clock signal.

20. An apparatus for wireless communication, comprising:
a transmit chain including an intermediate frequency circuit and a radio frequency circuit; and
a controller configured to:
detect that a gain associated with the transmit chain is to be increased;
in response to the detection, determine whether to increase a gain of the intermediate frequency circuit or the radio frequency circuit based on an output power of the radio frequency circuit compared to one or more thresholds; and
control an increase of the gain of the intermediate frequency circuit or the radio frequency circuit in accordance with the determination.
